(19) United States
(12) Patent Application Publication
(10) Pub. No.: US 2008/0202674 A1
(43) Pub. Date: Aug. 28, 2008

(54) STRUCTURAL REINFORCEMENTS

(75) Inventors: Dean Jeffrey Schneider, Washington, MI (US); Joseph L. Bolton, Troy, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/680,217

(22) Filed: Feb. 28, 2007

(51) Int. Cl. B29D 22/00

(52) U.S. Cl. 156/238; 428/542.8

(57) ABSTRACT

The present invention is predicated upon the provision of a system and method for reinforcement of a structural member, which may include attachment features for placement of an activatable material onto a carrier and/or attachment of the system to a structural member.

### FIELD OF THE INVENTION

The present invention is predicated upon the provision of a system and method for reinforcement of a structural member, which may include attachment features for placement of an activatable material onto a carrier and/or attachment of the system to a structural member.

### BACKGROUND OF THE INVENTION

For many years industry, and particularly the transportation industry has been concerned with providing functional attributes sealing, baffling, acoustic attenuation, sound dampening and reinforcement to articles of manufacture such as automotive vehicles. In turn, industry has developed a wide variety of materials and parts for providing such functional attributes. In the interest on continuing such innovation, the present invention seeks to provide an improved material and/or improved part for providing such functional attributes. The material and/or part can provide sealing, baffling, acoustic attenuation, sound dampening, combinations thereof or the like, but the part and/or material have been found to be particularly adept at providing reinforcement.

### SUMMARY OF THE INVENTION

The present invention provides systems and methods for improving structural frame members of transportation vehicles or otherwise.

In one aspect, the present invention provides a reinforcement system for a structural member. The system includes an integrally formed carrier member extending between a first and second end, the carrier member forming a plurality of cavities extending between the first and second end of the carrier. The system further includes an activatable material attached to the carrier and one or more fasteners for attachment of the carrier to an interior portion of a structural member.

In one aspect, the present invention provides a reinforcement system for a structural member. The system includes a carrier member having a length extending along an axis between a first end and a second end. The carrier member includes one or more sidewalls joined together to form one or more cavities extending along the axis, wherein the carrier includes a cross-sectional shape roughly corresponding to the cross-sectional shape of interior walls of a hollow structural member. The system also includes activatable material placed over the carrier, the activatable material configured to expand upon application of heat and adhere to the interior walls of the hollow structural member to provide reinforcement for the same. The system further includes one or more attachment features located on or integrated with the carrier member or activatable material for attaching the activatable material to the carrier and an additional one or more attachment features for attaching the carrier member to the interior walls of the hollow structural member, the one or more attachment features comprising fasteners located on the one or more sidewalls.

In one aspect, the present invention provides a method of reinforcing a structural member. The method includes the steps of: i) extruding a carrier member having a plurality of cavities extending along a length of the carrier; ii) attaching an activatable material to the carrier with one or more fasteners; and iii) attaching the carrier to an interior portion of a structural member.

It should be appreciated that the above referenced aspects and examples are non-limiting as other exists with the present invention as shown and described herein. Still further, it should be appreciated that the above referenced aspects and examples of the invention may be combined to form other unique configurations, as demonstrated in the drawings, or otherwise.

### BRIEF DESCRIPTION OF THE DRAWINGS

FIG. 1 illustrates an exemplary embodiment of a reinforcement system according to the teachings of the present invention.

FIG. 2 illustrates the exemplary reinforcement system shown in FIG. 1 inserted into a structural member.

FIG. 3 illustrates an exemplary embodiment of activatable reinforcement material having attachment features for attachment to a carrier.

FIGS. 4 through 9 illustrate various exemplary attachment features for placement of activatable reinforcement material onto a carrier.

FIGS. 10A and 10B illustrates another attachment feature for placement of activatable reinforcement material onto a carrier.

FIGS. 11A and 11B illustrates still another attachment feature for placement of activatable reinforcement material onto a carrier.

### DETAILED DESCRIPTION

The present invention is predicated upon a system and method of reinforcing a structural member, particularly an automotive frame or frame rail member. In doing so, the present invention contemplates a carrier having an activatable material place thereover, which is configured for placement within a hollow structural member. Subsequently, the activatable material is activated causing the carrier to attach to the structural member and provide reinforcement thereto.

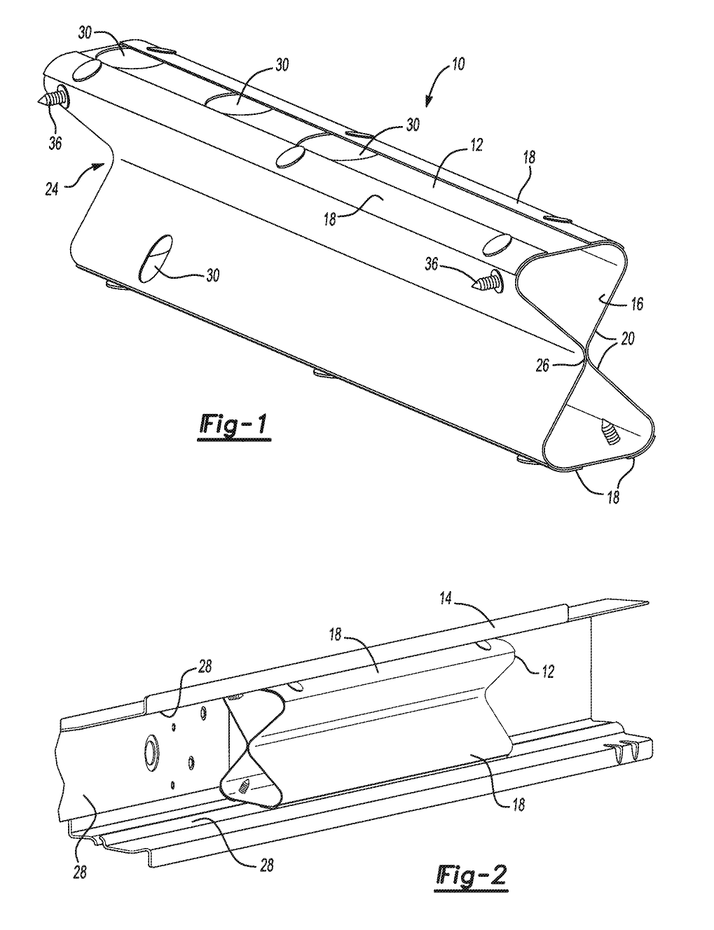

In one aspect, by example referring to FIGS. 1 and 2, the present invention contemplates an improved system 10, including a carrier member 12 configured for placement and attachment within a vehicle structural member 14. The carrier includes one or more cavities 16 extending the length of the carrier and the length of the structural member in which the carrier is placed into. Preferably, the carrier includes one or more applications of activatable material 18 placed thereover.

In yet another aspect, by example referring to FIGS. 3 through 9, the present invention also contemplates attachment features 20 for quick and inexpensive means for placement of an activatable material 18 onto a carrier member 12, as described herein or otherwise. The carrier member may be formed with one or more of these features which allows an activatable material to be located and attached to the carrier. Alternatively, or in addition to features located on the carrier, the activatable material may include one or more features that are configured for engaging the one or more features of the carrier for assisting in locating the expandable material relative to the carrier member. Upon placement, the movement of the activatable material is limited, substantially limited or prevented with respect to the carrier.

It should be appreciated that the above referenced examples are not limiting as other examples of these aspects are shown throughout the drawings and the skilled artisan will be able to contemplate other configurations that will remain within the scope of the present invention. Also, it should be appreciated that other features can be part of or can be employed in conjunction with the present invention such feature shown and described herein or elsewhere. Still further, it should be appreciated that the above referenced aspects of the invention may be combined to form other unique configurations, as demonstrated in the drawings, or otherwise.

### Carrier

The reinforcing system of the present invention includes a carrier adapted for placement within a hollow cavity of a structural member. The carrier is preferably configured to extend along an axis and more preferably along a length of the structural member. The carrier includes at least a first end and a second end which reside on opposite ends of an axis of the carrier. The carrier may also include one or more hollow cavities which extend along the length or axis of the carrier. The carrier can be straight or contoured along its length.

The carrier is formed of one or more walls that extend along the length of the carrier, which may be joined or otherwise integrated together. The carrier may have separate walls joined together by attachments such as adhesives or fasteners or the carrier may be integrally formed (e.g. molded) as a substantially unitary structure. Optionally, it is contemplated that the one or more of the walls may be internal walls located substantially within exterior walls of the carrier. Preferably, upon joining of the walls, the carrier forms one or more (or a plurality) of cavities (e.g., 1, 2, 3, 4, 5, 6 or more cavities) that extends along at least a portion of the length of the carrier and preferably substantially the entire length of the carrier. It is contemplated that the one or more cavities may form openings extending through the carrier between the first and second end of the carrier.

In one configuration, referring to FIGS. 1 and 2, the carrier includes one or more walls 22 that extend along the length of the carrier and which are joined together, particularly at a central portion 24. Preferably, a joint 26 formed by the connecting walls extends along the length of the carrier and divides the carrier member such that it has a first cavity 16′ and a second cavity 16″. This creates a cross sectional profile that provides improved strength and improved resistance to cross section forces, with respect to the carrier axis, because of the centrally connected walls and orientation thereof. In this configuration, a cross-sectional profile resembling a figure-eight is formed.

It is contemplated that one or more of the walls 22 of the carrier 12 may be located adjacent an interior wall 28 of the structural member 14 in which it is placed. For example, referring to FIG. 2, the at least two adjacent walls 22 may be located adjacent the interior structural wall 28. However, it is also contemplated that more or less than two walls may be located adjacent the interior structural wall member. For example, it is contemplated that the cross-sectional profile of the carrier, as defined by the walls 22, or otherwise, may correspond to the cross-sectional shape formed by the interior walls of the structural member 14. Accordingly, at least four walls may be located adjacent the interior structural members. Alternatively, the wall may have a single integrally formed wall. Numerous configurations should be appreciated.

Optionally, the carrier may include one or more through holes 30 formed in the walls of the carrier. The through holes may provide reduced weight of the carrier. The through holes may also be used to control any flow of the activatable material, or otherwise. Still further, the through holes may be used to engage any of the attachment features, or otherwise, as described herein, for attachment of the carrier to the structural member, or attachment of other components (e.g., activatable material or otherwise) to the carrier, also as described herein.

The carrier may be formed of a variety of materials and can be formed of a single material or multiple materials. As examples, the carrier may be formed of polymeric materials, metals (e.g., aluminum, steel, magnesium, metal alloys) combinations thereof or the like. Exemplary, polymeric materials (e.g., thermoplastics, rubber, elastomer, thermosets or the like), include, without limitation, polyester, polypropylene, polyamide, molding compounds (e.g., sheet or bulk molding compound), polyethylene, polyvinylchloride, combinations thereof or the like. As will be recognized, the technique for forming and shaping the carrier will typically depend upon the material of the carrier. Examples of techniques include, without limitation, molding, stamping, hydroforming or the like. Thus, the carrier could be a metal stamping, a metal casting (e.g., a metal, aluminum, aluminum foam, magnesium or magnesium foam casting), a thixomolded structure. The carrier could also be a molded (e.g., injection, compression or blow molded) plastic structure. Furthermore, it is contemplated that the carrier maybe formed through an extrusion process. Other forming methods are contemplated.

### Activatable Material

Preferably, the system 10 includes an activatable material 18 configured for providing structural reinforcement properties upon activation and curing thereof. In one configuration, the carrier includes activatable material located over the carrier. In one preferred configuration, the activatable material comprises an adhesive material, or otherwise includes adhesive qualities, for bonding to the carrier and structural member upon activation.

The activatable material may be placed and/or attached to the carrier using attachment techniques such as adhesion, fasteners or otherwise. However, in one preferred configuration, the carrier member and/or components associated with the carrier member attach the activatable material to the carrier. As previously mentioned, the attachment features may be integrally formed with, or otherwise attached, to the carrier, activatable material, or both.

The activatable material may be an expandable or foamable material that is activated to expand and then cure to form a strong bond between adjacent surfaces (e.g. attachment surfaces). When expandable, the adhesion material typically undergoes a volumetric expansion of no greater than 500%, more typically no greater than 300% and even more typically no greater than 150% over its original non-expanded volume. Of course, higher expansion levels are also contemplated within the present invention. The activatable material may also be a non-expandable adhesive material, which may or may not be heat activated.

In one embodiment, the activatable material is formed of a high compressive strength heat activated reinforcement material having foamable characteristics. The material may be generally dry to the touch or tacky and can be placed upon surfaces of members in any form of desired pattern, placement, or thickness, but is preferably a substantially uniform thickness. One exemplary expandable material is L-5204 structural foam available through L&L Products, Inc. of Romeo, Mich. Preferably the strength (e.g., tensile strength) of the adhesive material is at least about 5 Mpa, more preferably at least about 12 Mpa and even more preferably at least about 20 Mpa, although the strength may be lower as well.

Though other heat activated materials are possible for the activatable material, a preferred heat activated material is an expandable plastic, and preferably one that is foamable. A particularly preferred material is an epoxy-based structural foam. For example, without limitation, the structural foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based structural foams are known in the art and may also be used to produce the structural foam adhesive material. A typical structural foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the structural foam is usually initially processed as a flowable thermoplastic material before curing. It will cross-link upon curing, which makes the material incapable of further flow. An example of a preferred structural foam formulation for the adhesive material is an epoxy-based material that is commercially available from L&L Products of Romeo, Mich., under the designations L5206, L5207, L5208, L5209, L-5220, L-7102, L-7220, XP321 and XP721 or others.

One advantage of the preferred activatable materials over prior art materials is that the preferred materials can be processed in several ways. The preferred materials can be processed by injection molding, extrusion compression molding or with a mini-applicator. This enables the formation and creation of part designs that exceed the capability of most prior art materials. In one preferred embodiment, the structural foam (in its uncured state) generally is dry or relatively free of tack to the touch. Moreover, the activatable materials may be applied to the attachment surfaces of the members and/or connectors before or after assembly of those components together.

While the preferred materials for fabricating the activatable material have been disclosed, the materials can be formed of other materials as well. Such material can be heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, the desired characteristics of the structural foam include relatively high stiffness, high strength, high glass transition temperature (typically greater than 70 degrees Celsius), and good corrosion resistance properties. In this manner, the material does not generally interfere with the materials systems employed by automobile manufacturers.

In applications where the activatable material is a heat activated, thermally expanding material, an important consideration involved with the selection and formulation of the material is the temperature at which a material reaction, expansion, activation, flow and possibly curing, will take place. For instance, in most applications, it is undesirable for the material to be reactive at room temperature or otherwise at the ambient temperature in a production line environment. More typically, the material becomes reactive at higher processing temperatures, such as those encountered in an automobile assembly plant, when the material is processed along with the automobile components at elevated temperatures or at higher applied energy levels, e.g., during painting preparation steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges.

Generally, suitable materials have a range of expansion ranging from approximately 0 to over 1000 percent. The level of expansion of the materials may be increased to as high as 1500 percent or more. Typically, strength is obtained from products that possess low expansion.

Some other possible materials for use as the activatable material include, but are not limited to, polyolefin materials, copolymers and terpolymers with at least one monomer type an alpha-olefin, phenol/formaldehyde materials, phenoxy materials, and polyurethane. See also, U.S. Pat. Nos. 5,266,133; 5,766,719; 5,755,486; 5,575,526; 5,932,680; and WO 00/27920 (PCT/US 99/24795) (all of which are expressly incorporated by reference).

In another embodiment, the material may be provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

In addition, as discussed previously, preformed patterns may also be employed such as those made by extruding a sheet (having a flat or contoured surface) and then die cutting it according to a predetermined configuration in accordance with the chosen structure, panel or beam, and applying it thereto.

### Placement of Activatable Material

The activatable material 18 is attached or otherwise placed adjacent an exterior portion of the carrier 12. Preferably, the activatable material remains proximate to the carrier during placement within the structural member 14 or otherwise. The activatable material, carrier or both may include an attachment feature for attachment of the activatable material to the carrier. Optionally, the activatable material may also be placed on or with other components attached or otherwise associated with the carrier such as attachment or fastening devices (e.g. end caps), or otherwise.

In a first configuration, referring to FIGS. 1 and 2, the activatable material is attached to the carrier member through the use of one or more attachment features 20 such as mechanical attachment features or fasteners (e.g. threaded fasteners, Christmas tree clips, hook and latch, snap fittings, or otherwise). In particular, as shown, in this configuration Christmas tree clips are used to attach the material, wherein the clips extend through an opening formed in the activatable material and engage an opening formed in the carrier. Preferably, upon engagement the clips are generally flush with the material so as not to interfere with placement of the carrier within a structural member.

Referring to FIGS. 3 through 9, different configurations of attachment features for attachment of a strip of activatable material to a carrier are shown. The activatable material may be integrally formed with or otherwise include one or more fasteners for attachment of the activatable material to the carrier. It is contemplated that 2 or more (e.g. 3, 4, 5, 6 or more) fasteners may be used for this attachment. Preferably, the attachment feature is configured for engaging with the carrier, particularly a corresponding attachment feature (e.g. hole or otherwise) attached or otherwise formed with the carrier. Of course the corresponding attachment feature may be located on the activatable material wherein the fastener extends through the carrier to engage with the activatable material. Upon activation of the activatable material, the fastener is substantially non-obstructive to the expansion, adhesion or both of the activatable material. Additionally, it is contemplated that the fastener may even comprise or include activatable material as described herein.

In one specific example, referring to FIG. 3, a strip of activatable material is provided for placement with a carrier member. The activatable material includes fasteners 32 attached to the activatable material via a support member 34. The support member may comprise metal, nylon, Mylar, or other material suitable for acting as a mounting structure for the fastener. In this example the fastener is configured for removable attachment of the strip of activatable material to the carrier and specifically comprises a Christmas tree clip. The fasteners are suitable in length to extend beyond the activatable material and engage a corresponding feature (e.g. opening, slot or otherwise) located or formed on the carrier.

In another specific example, referring to FIG. 5, the fastener for the activatable material comprises a rivet, or the like, configured for permanent or semi-permanent attachment of the activatable material to the carrier. As with the previous example, the activatable material may include a support member for providing a suitable mounting structure for the rivet during attachment to the carrier. As may be expected, the rivet extends through an opening formed in the carrier for mounting to the same and expands at both ends to mount the activatable material to the carrier.

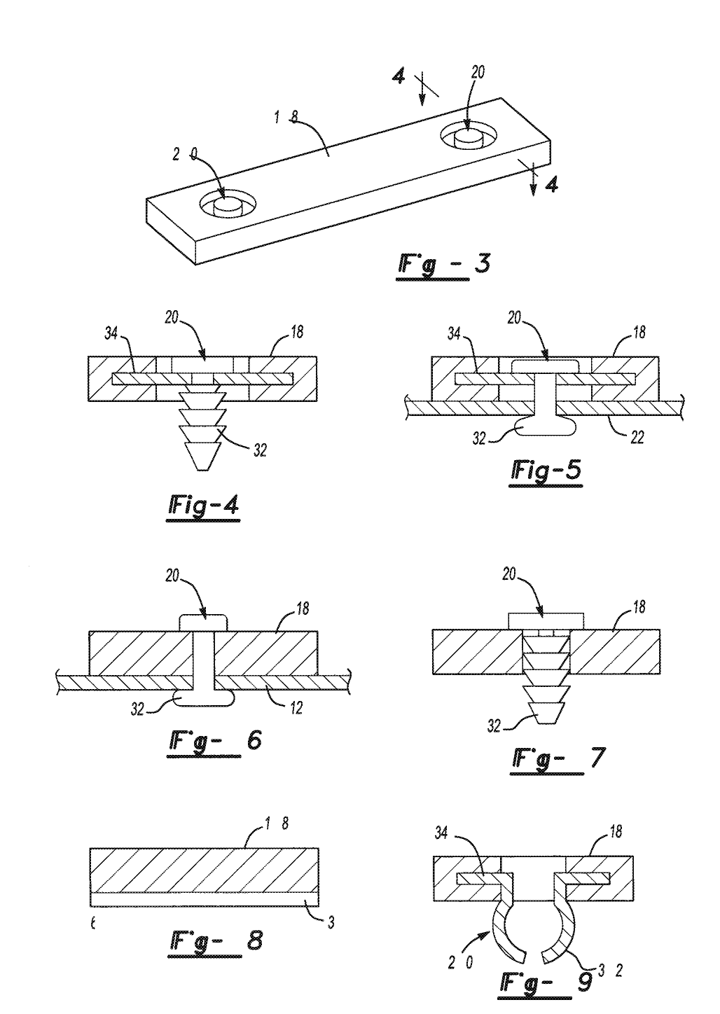

In another specific example, referring to FIGS. 6 and 7, the mechanical attachment feature (e.g. rivet, Christmas tree clip or otherwise) may be attached directly to the expandable material thereby forgoing the use of a support member. In these examples, the attachment feature extends through opening formed both in the expandable material and the carrier and mount similar to the example shown and described in FIGS. 4 and 5.

In another specific example, referring to FIG. 8, the fastener and support member may be replaced with an adhesive 36, such as a tacky adhesive, extending along at least a portion of one or more sides of the activatable material. In this configuration, the activatable material is adhesively bonded to the carrier through adhesive and maintains the same until, during and/or even after activation of the activatable material. Optionally, all or a portion of the activatable material may be configured with a tacky surface for bonding to the carrier.

In yet another specific example, referring to FIG. 9, the support member may be formed with one or more attachment features for attaching the activatable material to the carrier. In this configuration, the support member includes a resilient clipping feature which extends past the activatable material and is suitable in length to engage the carrier member. The clipping feature has a largest diameter greater than an opening formed in the carrier and optionally include a curved or angled portion for assisting in insertion through an opening formed in a carrier. Accordingly, as the clipping feature enters the opening of the carrier one or more portions of the clipping feature retracts, or otherwise, such that the largest diameter is less than or equivalent to the opening formed in the carrier. As the clipping moves through the opening it expands to once again form a diameter larger than the opening to limit or prevent the activatable material from moving away from the carrier. It should be appreciated that other attachment configurations formed by a support member are available.

In still another example, one or more of the attachment components or otherwise may be staked (e.g. heat or cold) to cause attachment of the activatable material to the carrier member. This may be achieved through deformation of one or more of the attachment components, or otherwise. In one application, heat staking may be used to cause an application of pressure and heat to plastically deform an attachment component to engage another attachment component. Alternatively, cold staking may be used to cause an application of pressure against a heated attachment component to plastically deform the same and cause it to engage another attachment component. Further, hot air may be used to cause deformation of one or more of the attachment components for deformation and engagement of the same. Still further, a heat activatable material, such as an adhesive or otherwise, may be applied between the activatable material and carrier, or may be formed therewith or applied thereto, wherein upon an application of heat, via heated air, hot press or otherwise, the activatable material and carrier become attached. In this configuration the heat activatable adhesive may have an activation level lower than the activation level of the activatable material being attached to the carrier. Also, in still another application, the carrier may be heated, via hot air or otherwise, to cause plastic deformation of the activatable material in order to engage the same. Other configurations are available to cause plastic deformation and/or attachment of the activatable material to the carrier.

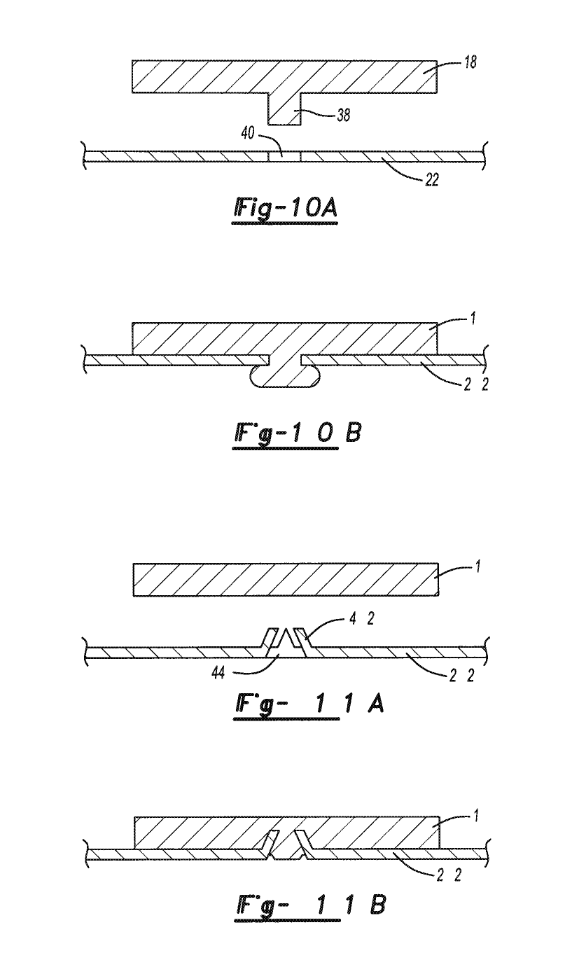

In view of the foregoing, Referring to FIGS. 10A and 10B, in one attachment configuration the activatable material 18 includes a projection 38 that is formed of a material that is plastically deformable. The plastically deformable material may be the same material used to form the activatable material or it may be different. The projection is placed through an opening 40 formed through the carrier. The projection is then staked (e.g. heat or cold staked) to cause the projection (such as the end portion or a combination of the end portion and middle portion) to plastically deform and form a diameter larger than the opening. This prevents removal of the projection from the opening. Alternatively, the carrier may include the projection and the activatable material may be formed with an opening, wherein the carrier is heat staked to the activatable material. Optionally, the activatable material and carrier are flush prior to heat staking so that movement of the activatable material with respect to the carrier is substantially limited.

In another configuration, referring to FIGS. 11A and 11B, another staked configuration is shown. In this configuration, the carrier includes one or more fingers 42 extending about the circumference of an opening 44 formed in the carrier. The carrier is heated to a suitable temperature to cause deformation of the activatable material upon contact. Upon placement activatable material onto the carrier, and application of a suitable force, the fingers puncture through the activatable material to engage the carrier and the activatable material. During this engagement, the material of the activatable material may enter the opening. Optionally, the activatable material and carrier are flush after heat staking so that movement of the activatable material with respect to the carrier is substantially limited.

It should be appreciated that any that the above examples or features may be combined to form additional embodiments. Also, it should be appreciated that other configurations are available.

### Other Attachment Features

Optionally, the carrier may include one or more additional attachment features for mounting the carrier to a structural member and more particularly to an interior walls forming the hollow cavity of the structural member. Such attachment features may be integrally formed with the carrier or comprise a separate attachment feature which is attached to the carrier and configured for matingly engaging with the structural member. Suitable attachment features include mechanical fasteners (e.g. threaded fasteners, hook and latch, snap fittings, Christmas tree clips, or otherwise). Other fasteners include non-mechanical fasteners (e.g. friction fittings, adhesives, or otherwise).

The fasteners may be formed or placed about portions of the carrier to attach the same to a structural member. However, preferably, at least one attachment feature is located at the first end of the carrier and at least one end is located at the second end of the carrier. Thus it is possible to generally orientate the axis of the carrier with the axis of the structural cavity.

By example, referring to FIGS. 1 and 2, an example of suitable attachment features are shown. In this example, the attachment feature comprises mechanical fasteners 36 that are separately formed and configured for engagement with an opening formed in the carrier, or otherwise. The fasteners extend through the opening and matingly engage with an opening formed in an interior surface of a structural member to secure the carrier thereto.

### Applications

The reinforcing system of the present invention may be used in a variety of applications which includes a structural member and which may benefit from reinforcement thereof. In one particular application, the system may be used in the vehicular industry for reinforcing structural systems thereof to form a reinforced structural member. In doing so, any of the systems herein can be placed in a structural member and activated to form the reinforced structural member.

For example, it is contemplated that the system may be used to reinforce various structural members of a vehicle including frame, frame rails, rockers, pillars, roof members, or otherwise. The structural member may comprise one or more frame components (such as tubular frame members or otherwise) extending the length of a vehicle and/or other frame members located therebetween (e.g. rocker frame members). In one particularly advantageous application, the system may be used to reinforce a frame rail, rocker, or the like depending on the type of frame (e.g. unibody, etc.).

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A reinforcement system for a structural member, the system comprising:
an integrally formed carrier member extending between a first and second end, the carrier member defining a first and second cavity extending between the first and second end of the carrier which are divided by an intermediate portion of the carrier;
an expandable heat activatable material attached to the carrier;
one or more fasteners for attachment of the carrier to an interior portion of a structural member; and
wherein the carrier member includes a cross-sectional shape that: i) generally corresponding to a cavity formed by the structural member, and ii) has a shape that resemble a figure-eight.

2. The reinforcement system of claim 1, wherein the carrier is formed of one or more sidewalls having openings formed therein for engagement with a fastener for attachment of the carrier to a structural member or for attachment of the activatable material to the carrier.

3. The reinforcement system of claim 1, wherein the activatable material is attached to the carrier with a mechanical fastener.

4. The reinforcement system of claim 1, wherein the activatable material includes a support member for engagement with a mechanical fastener for attachment of the activatable material to the carrier, wherein the mechanical fastener comprises a rivet or clip that is configured to extend through the support member and carrier to attach the activatable material to the carrier.

5. The reinforcement system of claim 1, wherein the activatable material includes a support member having an integrally formed mechanical fastener for attachment of the activatable material to the carrier, and wherein the support member is formed of a material different than the activatable material.

6. The reinforcement system of claim 1, wherein the activatable material is attached to the carrier with an adhesive.

7. The reinforcement system of claim 1, wherein the adhesive is a heat activated adhesive having an activation level lower than the activation level of the activatable material.

8. The reinforcement system of claim 1, wherein the activatable material is formed with an attachment feature for engaging a corresponding attachment feature formed on the carrier, and wherein the attachment feature of the activatable material is also activatable.

9. The reinforcement system of claim 1, wherein the carrier includes a plurality of fingers formed about an opening for engaging and attaching the activatable material to the carrier.

10. A reinforcement system for a structural member, the system comprising:
a carrier member having a length extending along an axis between a first end and a second end, the carrier member including one or more sidewalls joined together to form one or more cavities extending along the axis, the carrier including a cross-sectional shape roughly corresponding to the cross-sectional shape of interior walls of a hollow structural member;
an expandable heat activatable material heat staked to the carrier, the activatable material configured to expand upon application of heat and adhere to the interior walls of the hollow structural member to provide reinforcement for the same;
one or more attachment features for attaching the carrier member to the interior walls of the hollow structural member, the one or more attachment features comprising fasteners located on the one or more sidewalls.

11. The reinforcement system of claim 10, wherein the activatable member is formed with one or more projections for extending through openings formed through a surface of the carrier, wherein upon heat staking the one or more projections include an exterior diameter larger than an interior diameter of the openings.

12. The reinforcement system of claim 10, wherein the carrier is formed with one or more projections for extending through openings formed through the activatable material, wherein upon heat staking the one or more projections include an exterior diameter larger than an interior diameter of the openings.

13. The reinforcement system of claim 10, wherein the carrier inclu es one or more openings surrounded by a plurality of outwardly extending fingers, the plurality of fingers extending through a portion of the activatable material.

14. A method of reinforcing a structural member including the steps of:
extruding a carrier member having a plurality of cavities extending along a length of the carrier;
attaching an expandable heat activatable material to the carrier; and
attaching the carrier to an interior portion of a structural member.

15. The method of claim 14, wherein the carrier member is extruded to include a cross-section shape resembling a figure-eight.

16. The method of claim 15, wherein the activatable material is preassembled with one or more fasteners configured to attach the activatable material to the carrier.

17. The method of claim 16, wherein the activatable material is formed onto a support member configured to engage with the fasteners used to attach the activatable material to the carrier.

18. The method of claim 15, wherein attachment of the activatable material to the carrier comprising the step of heat staking the activatable material to the carrier member.

19. The reinforcement system of claim 18, wherein the carrier is formed with one or more projections for extending through openings formed through the activatable material, wherein upon heat staking the one or more projections include an exterior diameter larger than an interior diameter of the openings.

20. The reinforcement system of claim 18, wherein the carrier includes one or more openings surrounded by a plurality of outwardly extending fingers, and wherein the plurality of fingers extend through the activatable material during the heat staking process.
